(19) United States
(12) Patent Application Publication
(10) Pub. No.: US 2010/0010663 A1
(43) Pub. Date: Jan. 14, 2010

(54) BANKNOTE HANDLING APPARATUS AND METHOD OF CONTROLLING BANKNOTE HANDLING APPARATUS

(75) Inventors: Toshiyuki Nakamura, Tokyo-To (JP); Osamu Ito, Saitama-Ken (JP); Hirofumi Ozaki, Tokyo-To (JP)

Correspondence Address: BURR & BROWN, PO BOX 7068, SYRACUSE, NY, 13261-7068, US

(73) Assignee: Glory Ltd., Himeji-Shi ,Hyogo-ken (JP)

(21) Appl. No.: 12/444,029

(22) PCT Filed: Oct. 6, 2006
(86) PCT No.: PCT/JP2006/320119

§ 371 Date: Apr. 2, 2009

(51) Int. Cl. G06F 7/00; G07D 7/00

(52) U.S. Cl. 700/223

(57) ABSTRACT

A banknote handling apparatus that can easily designate attributes of banknotes to be stacked on stacking units and a method of controlling the apparatus. The apparatus includes a control unit that controls the banknote handling apparatus, a hopper that feeds out banknotes according to an instruction of the control unit, a plurality of stacking units that stack the banknotes according to an attribute of the banknotes, a recognition unit that recognizes the attribute of the banknotes fed out from the hopper, and an operation unit that accepts a predetermined instruction. The control unit causes the hopper to feed out the banknotes, causes the recognition unit to recognize the attribute of the banknotes, and designates the attribute of the recognized banknotes as the attribute of the banknotes to be stacked on a predetermined stacking unit when an instruction of a stacking unit setting mode is accepted through the operation unit.

### TECHNICAL FIELD

The present invention relates to a banknote handling apparatus and a method of controlling the banknote handling apparatus, and particularly, to a banknote handling apparatus and a method of controlling the banknote handling apparatus that include a plurality of stacking units and that can easily designate attributes of banknotes to be stacked on the stacking units.

### BACKGROUND ART

In banknote handling apparatuses of recent years, operations required for setting the functions are complicated along with the complication of the functions, and the setting operations cannot be easily performed.

For example, Japanese Patent Laid-Open No. 3-6688 (hereinafter, “Patent Document 1”) discloses a stacker denomination setting apparatus that includes a plurality of stacking units and that can freely and easily set the denominations of banknotes to be stored in the stacking units. The stacker denomination setting apparatus sorts the denominations based on a code inputted from a stacker denomination setting switch when the power switch is set ON.

However, the stacker denomination setting apparatus disclosed in Patent Document 1 requires a code input from the stacker denomination setting switch for setting the stacker denomination. Therefore, the setting cannot be easily performed when the operation of the code input is complex, and erroneous operations are easily induced.

### DISCLOSURE OF THE INVENTION

An object of the present invention is to provide a banknote handling apparatus and a method of controlling the banknote handling apparatus that can easily designate attributes of banknotes to be stacked on each of a plurality of stacking units without imposing complex operations, such as a predetermined code input, on the operator.

According to a first aspect of the present invention, there is provided a banknote handling apparatus characterized by comprising:

a control unit that controls the banknote handling apparatus;

a hopper that feeds out banknotes according to an instruction of the control unit;

a plurality of stacking units that stack the banknotes according to an attribute of the banknotes;

a recognition unit that recognizes the attribute of the banknotes fed out from the hopper; and

an operation unit that accepts a predetermined instruction, wherein

the control unit causes the hopper to feed out the banknotes, causes the recognition unit to recognize the attribute of the banknotes, and designates the attribute of the recognized banknotes as the attribute of the banknotes to be stacked on a predetermined stacking unit when an instruction of a stacking unit setting mode is accepted through the operation unit.

According to a second aspect of the present invention, there is provided a method of controlling a banknote handling apparatus characterized by comprising:

accepting an instruction of a mode for designating stacking units;

feeding banknotes from a hopper;

recognizing an attribute of the fed banknotes;

selecting one of a plurality of stacking units as a selection stacking unit; and

designating the attribute of the recognized banknotes as the attribute of the banknotes to be stacked on the selected selection stacking unit.

According to the present invention, attributes of banknotes to be stacked on each of a plurality of stacking units can be easily designated, and moreover, the burden on the operator and erroneous operations can be reduced, and the processing efficiency of the banknote handling apparatus can be improved.

### BRIEF DESCRIPTION OF THE DRAWINGS

FIG. 1 is a perspective view of an appearance of a banknote handling apparatus 100 according to the embodiment of the present invention.

FIG. 2 is a plan view of an internal structure of the banknote handling apparatus 100 according to the embodiment of the present invention.

FIG. 3 is a block diagram of a configuration of the banknote handling apparatus 100 according to the embodiment of the present invention.

FIGS. 4(a) to 4(e) illustrate data configurations showing an example of the stacking information 302b according to the embodiment of the present invention.

FIG. 5 is a flow chart of an example of a procedure of the control unit 301 in a stacking unit designation mode according to the embodiment of the present invention.

FIG. 6 is a flow chart of an example of a procedure of the control unit 301 in the stacking mode according to the embodiment of the present invention.

### BEST MODE FOR CARRYING OUT THE INVENTION

An embodiment of the present invention will be described below with reference to the drawings. The embodiment below is only a mode of the present invention and does not limit the scope of the present invention.

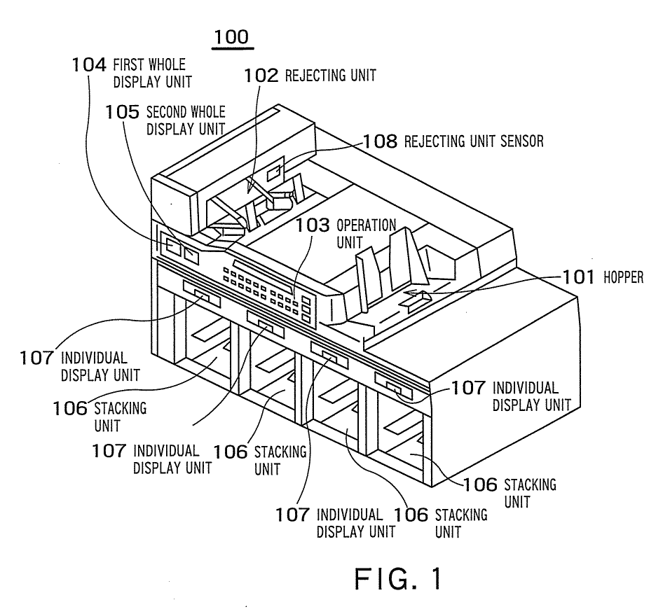

FIG. 1 is a perspective view of an appearance of a banknote handling apparatus 100 according to the embodiment of the present invention.

The banknote handling apparatus 100 according to the embodiment of the present invention includes a hopper 101, a rejecting unit 102, an operation unit 103, a first whole display unit 104, a second whole display unit 105, four stacking units 106, four individual display units 107, and a rejecting unit sensor 108.

The hopper 101 feeds out banknotes placed by the operator into the banknote handling apparatus 100. The rejecting unit 102 dispenses the banknotes when the banknotes fed out by the hopper 101 are rejected banknotes (for example, “counterfeit notes”). The rejecting unit sensor 108 arranged on the rejecting unit 102 can detect whether a light shielding object (for example, operator's hand, banknotes, and so forth) has shielded the light. The operation unit 103 includes input keys for accepting an instruction from the operator. The first whole display unit 104 and the second whole display unit 105 display predetermined data (for example, graphic data). The stacking unit 106 stacks the banknotes fed out from the hopper 101 for each attribute of the banknotes and detects full states. The individual display units 107 are arranged corresponding to the stacking units 106 and display the number of banknotes stacked on the corresponding stacking units 106. Although FIG. 1 illustrates four stacking units 106 and individual display units 107, the numbers of the stacking units 106 and the individual display units 107 are not limited to four.

In the present embodiment, the first whole display unit 104 and the second whole display unit 105 are graphic-type liquid crystal displays (LCDs). The individual display units 107 are character-type one-line LCDs.

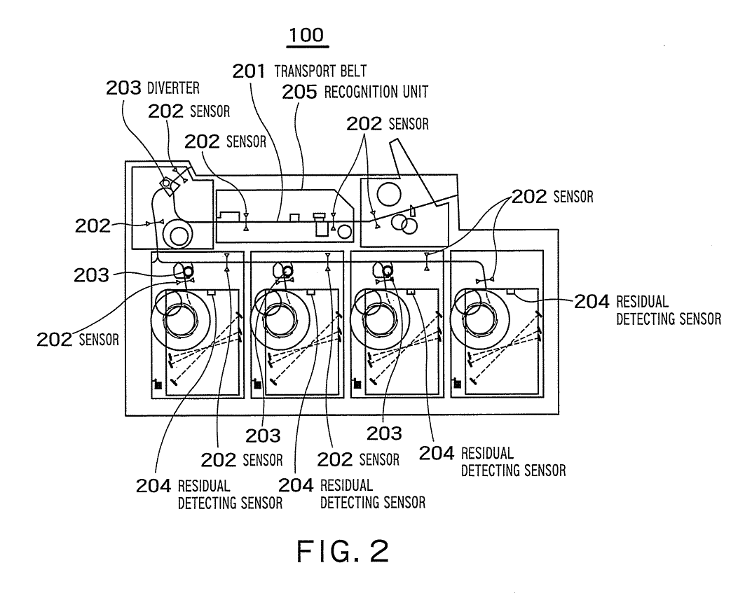

FIG. 2 is a plan view of an internal structure of the banknote handling apparatus 100 according to the embodiment of the present invention.

The banknote handling apparatus 100 according to the embodiment of the present invention internally includes a transport belt 201, sensors 202, diverters 203, residual detecting sensors 204, and a recognition unit 205.

The transport belt 201 transports the banknotes sent from the hopper 101 to the rejecting unit 102 or the stacking units 106. The sensors 202 are installed at a plurality of locations and detect jams at the locations. The diverters 203 are installed at diverging points of the rejecting unit 102 and the plurality of stacking units 106 and divert the pathway on the transport belt 201. The residual detecting sensor 204 is associated and installed in each stacking unit 106 and can detect whether a light shielding object has shielded the light. The recognition unit 205 recognizes attributes of the banknotes (“whether the banknotes are counterfeit notes”, “fit note/unfit note and damage level”, “denomination”, “new note/old note”, “orientation”, and so forth). Although FIG. 2 illustrates four residual detecting sensors 204, the number of the residual detecting sensors 204 is not limited to four and corresponds to the number of the stacking units 106.

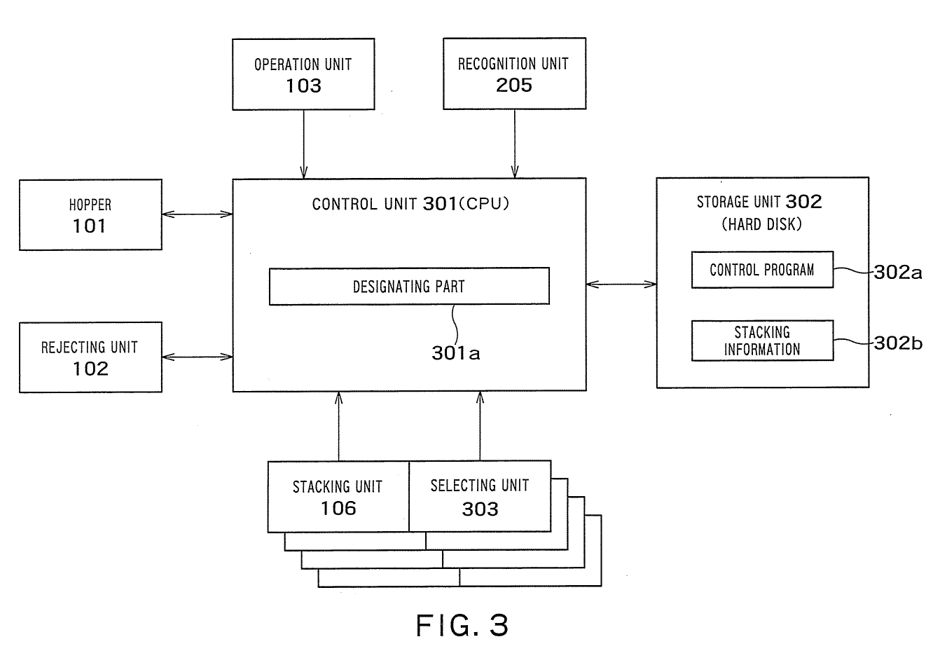

FIG. 3 is a block diagram of a configuration of the banknote handling apparatus 100 according to the embodiment of the present invention.

A control unit 301 that controls the banknote handling apparatus 100 according to the present invention is connected to an operation unit 103, a recognition unit 205, a storage unit 302, selecting units 303, the stacking units 106, the rejecting unit 102, and the hopper 101. The control unit 301 includes designating part 301a designating attributes of the banknotes to be stacked on the stacking units 106 and attributes of the banknotes to be dispensed to the rejecting unit 102. The control unit 301 also instructs the hopper 101 to start feeding out the banknotes, instructs the rejecting unit 102 to dispense the banknotes, and instructs the recognition unit 205 to recognize the attributes of the banknotes. The control unit 301 also accepts an instruction of the operator through the operation unit 103, accepts the recognition result (attributes of the banknotes) from the recognition unit 205, accepts information (which stacking units 106 are selected) related to the stacking units selected as selection stacking units among the plurality of stacking units 106 from the selecting units 303, accepts information related to whether the stacking units 106 are full states (stacking unit is full), accepts information related to whether the light is shielded from the rejecting unit sensor 108 by a light shielding object from the rejecting unit 102, and accepts information related to whether the banknotes are placed from the hopper 101. The control unit 301 also reads and writes data to and from the storage unit 302.

The storage unit 302 can store a control program 302a and stacking information 302b. The control program 302a is a program executed by the control unit 301 to control the banknote handling apparatus 100. The stacking information 302b is information which is read out when the banknotes placed on the hopper 101 are stacked and which is a condition for transporting the banknotes to the plurality of stacking units 106 or the rejecting unit 102.

In the present embodiment, the control unit 301 is realized by a CPU, the storage unit 302 is realized by a computer-readable storage medium such as a hard disk, and so forth, and the selecting units 303 are realized by the residual detecting sensors 204.

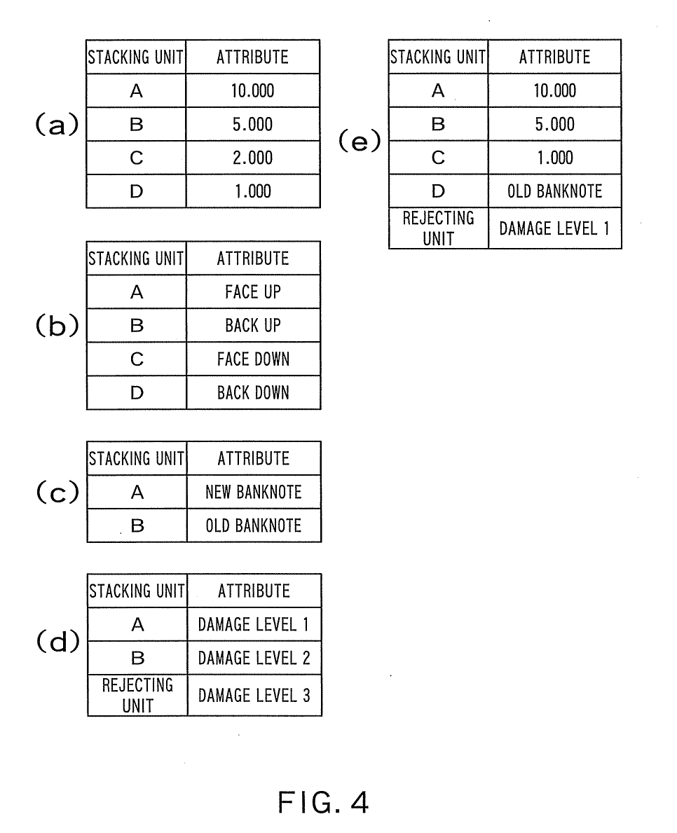

FIGS. 4(a) to 4(e) illustrate data configurations showing an example of the stacking information 302b according to the embodiment of the present invention.

FIG. 4(a) is an example of the stacking information 302b when the banknotes are stacked according to the denomination. As shown in FIG. 4(a), the stacking information 302b is constituted by information specifying the stacking units 106 and information indicating the denomination of the banknotes. FIG. 4(a) is an example of the stacking information 302b in which a stacking unit A is designated as the stacking destination of 10,000-yen bills, a stacking unit B is designated as the stacking destination of 5,000-yen bills, a stacking unit C is designated as the stacking destination of 2,000-yen bills, and a stacking unit D is designated as the stacking destination of 1,000-yen bills.

FIG. 4(b) is an example of the stacking information 302b when the banknotes are stacked according to the orientation (face/back and up/down). As shown in FIG. 4(b), the stacking information 302b is constituted by information specifying the stacking units 106 and information indicating the orientation of the banknotes. FIG. 4(b) is an example of the stacking information 302b in which the stacking unit A is designated as the stacking destination of face-side and upward banknotes, the stacking unit B is designated as the stacking destination of back-side and upward banknotes, the stacking unit C is designated as the stacking destination of face-side and downward banknotes, and the stacking unit D is designated as the stacking destination of back-side and downward banknotes.

FIG. 4(c) is an example of the stacking information 302b when the banknotes are stacked according to new/old of the banknotes (new banknotes/old banknotes). As shown in FIG. 4(c), the stacking information 302b is constituted by information specifying the stacking units 106 and information indicating new banknotes/old banknotes. FIG. 4(c) is an example of the stacking information 302b in which the stacking unit A is designated as the stacking destination of the new banknotes, and the stacking unit B is designated as the stacking destination of the old banknotes.

FIG. 4(d) is an example of the stacking information 302b when the banknotes are transported to the stacking units 106 or the rejecting unit 102 according to the damage level of the banknotes. As shown in FIG. 4(d), the stacking information 302b is constituted by information specifying the stacking units 106, information indicating the rejecting unit 102, and information indicating the damage level of the banknotes. FIG. 4(d) is an example of the stacking information 302b in which the stacking unit A is designated as the stacking destination of a damage level 1 (banknotes with the lowest damage level), the stacking unit B is designated as the stacking destination of a damage level 2 (banknotes with low damage level), and the rejecting unit 102 is designated as the transport destination of a damage level 3 (banknotes with the highest damage level).

FIG. 4(e) is an example of the stacking information 302b when the banknotes are stacked in combination of denomination of banknotes, new banknotes/old banknotes, and damage level. As shown in FIG. 4(e), the stacking information 302b is constituted by information specifying the stacking units 106 or the rejecting unit 102 and attributes of banknotes (denomination, new banknotes/old banknotes, and damage level). FIG. 4(e) is an example of the stacking information 302b in which the stacking unit A is designated as the stacking destination of 10,000-yen bills, the stacking unit B is designated as the stacking destination of 5,000-yen bills, the stacking unit C is designated as the stacking destination of 1,000-yen bills, the stacking unit D is designated as the stacking destination of the old banknotes, and the rejecting unit 102 is designated as the transport destination of the unfit notes.

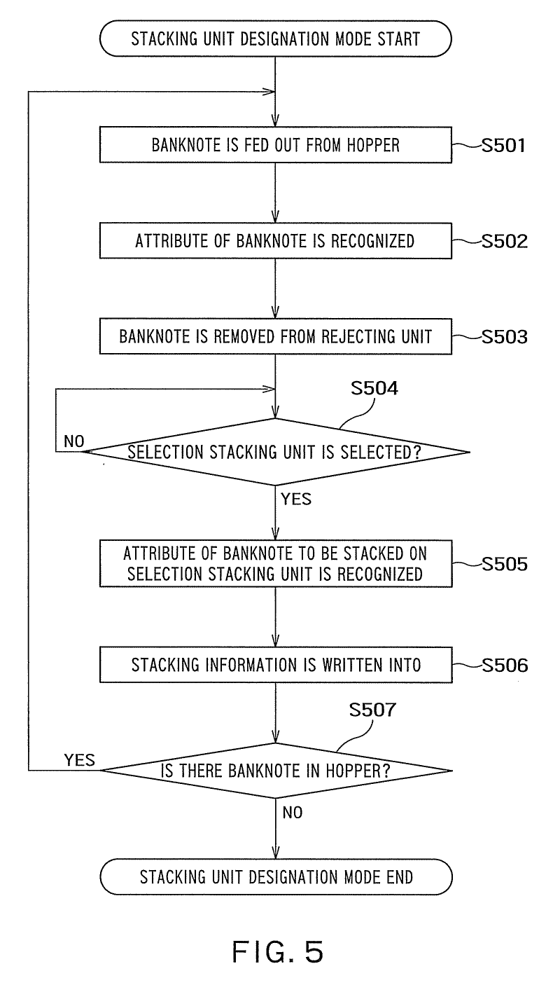

FIG. 5 is a flow chart of an example of a procedure of the control unit 301 in a stacking unit designation mode according to the embodiment of the present invention. An example that a “denomination designation mode (mode for designating the stacking units for each denomination)” is instructed will be described. When the operator instructs the stacking unit designation mode, it is preferable to place sample notes on the hopper 101. In the case of the “denomination designation mode”, it is preferable to place the sample notes of each denomination on the hopper 101.

First, when the instruction of the stacking unit designation mode (“denomination designation model”) is accepted through the operation unit 103, the hopper 101 is controlled to feed out the banknotes (sample notes) (S501). Subsequently, the recognition unit 205 is controlled to recognize the attribute (denomination) of the fed out banknotes (S502). Subsequently, the rejecting unit 102 is controlled to dispense the banknotes (S503). Subsequently, the process waits until a selection stacking unit is selected (S504—No). The determination of whether the selection stacking unit is selected (S504) is performed based on whether the light is shielded from the residual detecting sensors 204 or the rejecting unit sensor 108 by a light shielding object such as operator's hand and banknotes. When a selection stacking unit is selected (S504—Yes), the attribute (denomination) of the banknotes recognized in S502 is designated as the attribute of the banknotes to be stacked on the selected selection stacking unit (S505). Subsequently, information formed of a combination of the selected selection stacking unit and the attributes of the designated banknotes is written into the storage unit 302 as the stacking information 302b (see FIG. 4(a)) (S506). Subsequently, the process jumps to S501 when there are banknotes in the hopper 101 (S507—Yes), and the “stacking unit designation mode” ends when there is no banknote in the hopper 101 (S507—No).

In S504 of FIG. 5, it is determined that the selection stacking unit is selected when the light is shielded from the residual detecting sensor 204 by the light shielding object. However, keys corresponding to the plurality of stacking units 106 may be arranged, and when one of the keys is pressed, the stacking unit corresponding to the pressed key may be selected as the selection stacking unit.

Although an example that the “denomination designation mode” is instructed is described in FIG. 5, the same applies when other modes are instructed. Examples of other modes include “orientation mode (mode for designating the stacking units for each face/back and up/down of banknotes)”, “new/old mode (mode for designating stacking units for new banknotes and old banknotes)”, “unfit note level mode (mode for designating the stacking units for each damage level)”, and “combination mode (mode for designating the stacking units in combination of denomination, orientation, and new/old)”.

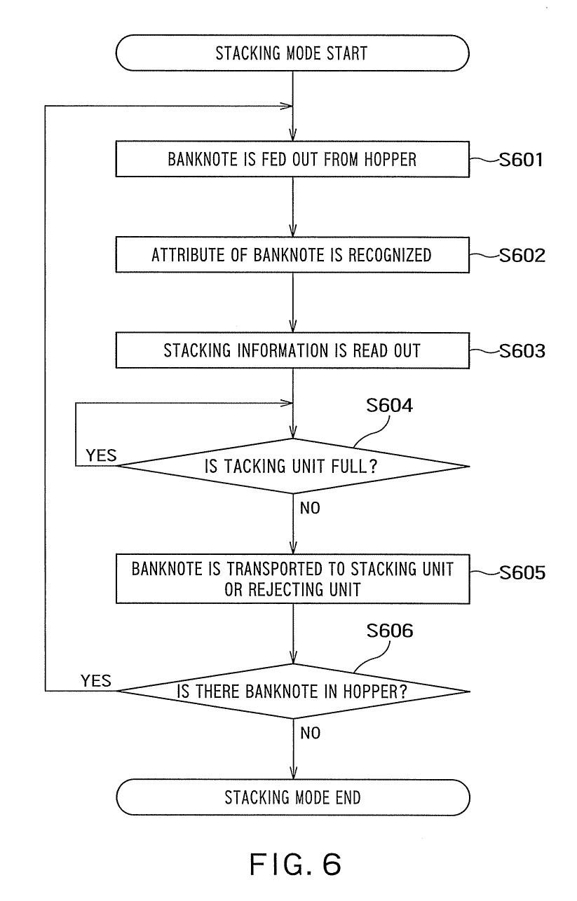

FIG. 6 is a flow chart of an example of a procedure of the control unit 301 in the stacking mode (mode for sorting and stacking the banknotes placed on the hopper 101 to the stacking units 106) according to the embodiment of the present invention.

First, when an instruction of the stacking mode is accepted through the operation unit 103, the hopper 101 is controlled to feed out the banknotes (S601). Subsequently, the recognition unit 205 is controlled to recognize the attributes of the banknotes (S602). Subsequently, the stacking information 302b stored in the storage unit 302 is read out (S603). Subsequently, based on the attributes of the banknotes recognized in S602 and the stacking information 302b, whether the stacking unit as the stacking destination is full state (stacking unit is full) is determined (S604). The banknote handling apparatus 100 according to the embodiment of the present invention becomes a standby state when the stacking unit is full (S504—Yes). The banknotes are transported to the stacking unit 106 or the rejecting unit 102 (S605) when the stacking unit is not full (S604—No). Subsequently, the process jumps to S601 when the banknotes remain in the hopper 101 (S606—Yes), and the stacking mode ends when there is no banknotes in the hopper 101 (S606—No).

According to the present embodiment, when the instruction of the “stacking unit designation mode” is accepted, the stacking information 302b is written into the storage unit 302 based on the recognition result of the recognition unit 205 and the selection result of the selecting unit 303. Therefore, the burden of the operator and the erroneous operations can be reduced without imposing complex operations on the operator.

The stacking destination is designated based on the result of recognizing the sample notes. Therefore, the operator can intuitively designate the stacking condition (which banknotes are stacked on which stacking unit).

1. A banknote handling apparatus comprising:
a control unit that controls the banknote handling apparatus;
a hopper that feeds out banknotes according to an instruction of the control unit;
a plurality of stacking units that stack the banknotes according to an attribute of the banknotes;
a recognition unit that recognizes the attribute of the banknotes fed out from the hopper; and
an operation unit that accepts a predetermined instruction, wherein
the control unit causes the hopper to feed out the banknotes, causes the recognition unit to recognize the attribute of the banknotes, and designates the attribute of the recognized banknotes as the attribute of the banknotes to be stacked on a predetermined stacking unit when an instruction of a stacking unit setting mode is accepted through the operation unit.

2. The banknote handling apparatus according to claim 1, further comprising
a selecting unit that selects one of the plurality of stacking units as a selection stacking unit,
wherein the control unit designates the attribute of the banknotes recognized by the recognition unit as the attribute of the banknotes to be stacked on the selection stacking unit selected by the selecting unit when the instruction of the stacking unit setting mode is accepted through the operation unit.

3. The banknote handling apparatus according to claim 2,
wherein the selecting unit is an optical sensor arranged corresponding to each of the plurality of stacking units, and when the light of the optical sensor is shielded, selects the stacking unit corresponding to the optical sensor shielded from the light as the selection stacking unit.

4. The banknote handling apparatus according to claim 1, further comprising
a rejecting unit that can dispense the banknotes fed out from the hopper,
wherein the control unit causes the hopper to feed out the banknotes, causes the recognition unit to recognize the attribute of the banknotes, and causes the rejecting unit to dispense the banknotes when the instruction of the mode for designating stacking units is accepted through the operation unit.

5. The banknote handling apparatus according to claim 1,
wherein the attribute of the banknotes is denomination of the banknotes, orientation, face or back, damage level, or new banknote or old banknote.

6. A method of controlling a banknote handling apparatus comprising:
accepting an instruction of a mode for designating stacking units;
feeding banknotes from a hopper;
recognizing an attribute of the fed banknotes;
selecting one of a plurality of stacking units as a selection stacking unit; and
designating the attribute of the recognized banknotes as the attribute of the banknotes to be stacked on the selected selection stacking unit.

7. The method of controlling a banknote handling apparatus according to claim 6, the control method further comprising
dispensing the recognized banknotes from a rejecting unit after the recognizing,
wherein the selecting is performed after the dispensing.

8. The method of controlling a banknote handling apparatus according to claim 6,
wherein the attribute of the banknotes is denomination of the banknotes, orientation, face or back, damage level, or new banknote or old banknote.

9. The banknote handling apparatus according to claim 2, further comprising
a rejecting unit that can dispense the banknotes fed out from the hopper,
wherein the control unit causes the hopper to feed out the banknotes, causes the recognition unit to recognize the attribute of the banknotes, and causes the rejecting unit to dispense the banknotes when the instruction of the mode for designating stacking units is accepted through the operation unit.

10. The banknote handling apparatus according to claim 3, further comprising
a rejecting unit that can dispense the banknotes fed out from the hopper,
wherein the control unit causes the hopper to feed out the banknotes, causes the recognition unit to recognize the attribute of the banknotes, and causes the rejecting unit to dispense the banknotes when the instruction of the mode for designating stacking units is accepted through the operation unit.

11. The banknote handling apparatus according to claim 2, wherein the attribute of the banknotes is denomination of the banknotes, orientation, face or back, damage level, or new banknote or old banknote.

12. The banknote handling apparatus according to claim 3, wherein the attribute of the banknotes is denomination of the banknotes, orientation, face or back, damage level, or new banknote or old banknote.

13. The banknote handling apparatus according to claim 4, wherein the attribute of the banknotes is denomination of the banknotes, orientation, face or back, damage level, or new banknote or old banknote.

14. The method of controlling a banknote handling apparatus according to claim 7, wherein the attribute of the banknotes is denomination of the banknotes, orientation, face or back, damage level, or new banknote or old banknote.
